(19) United States
(12) Patent Application Publication
(10) Pub. No.: US 2025/0297453 A1
(43) Pub. Date: Sep. 25, 2025

(54) WORKING MACHINE

(71) Applicant: Kubota Corporation, Osaka (JP)

(72) Inventor: Hiroyuki TAKAKI, Sakai-shi (JP)

(21) Appl. No.: 19/229,072

(22) Filed: Jun. 5, 2025

Related U.S. Application Data
(63) Continuation of application No. PCT/JP2023/046116, filed on Dec. 22, 2023.

(30) Foreign Application Priority Data
Dec. 26, 2022 (JP) 2022-208917

(51) Int. Cl. E02F 9/08; E05D 3/02; E05D 5/06; E05F 5/08

(52) U.S. Cl. CPC E02F 9/0891; E02F 9/0883; E05D 3/02; E05D 5/062; E05F 5/08; E05D 2005/067; E05Y 2201/224; E05Y 2900/518; E05Y 2900/534

(57) ABSTRACT

A working machine includes a machine body, tank(s) provided in the machine body and including a fluid supply port, a cover body to cover the tank, the cover body including a main wall portion and an opening provided in a portion of the main wall portion to expose the fluid supply port, a fluid supply port cover to open and close the opening, and a hinge to support the fluid supply port cover in a rotatable manner. The hinge includes an abutting portion to abut on an abutted portion at an opening peripheral edge portion that is a peripheral edge portion of the opening of the cover body or in a vicinity of the opening peripheral edge portion from an inner side of the machine body, to limit rotation in an opening direction of the fluid supply port cover when the fluid supply port cover is rotated and opened.

### CROSS REFERENCE TO RELATED APPLICATIONS

This application is a continuation application of International Application No. PCT/JP2023/046116, filed on Dec. 22, 2023, which claims the benefit of priority to Japanese Patent Application No. 2022-208917, filed on Dec. 26, 2022. The entire contents of each of these applications are hereby incorporated herein by reference.

### BACKGROUND OF THE INVENTION

### 1. Field of the Invention

The present invention relates to working machines such as backhoes.

### 2. Description of the Related Art

A working machine disclosed in Japanese Unexamined Patent Application Publication No. 10-331196 is known.

The working machine disclosed in Japanese Unexamined Patent Application Publication No. 10-331196 includes a cover body that covers a tank provided in a machine body, and the cover body is provided with an opening to expose a fluid supply port provided at an upper portion of the tank, and a fluid supply port cover that opens/closes the opening. The fluid supply port cover is supported by the cover body via a hinge so as to be rotatable upward/downward.

### SUMMARY OF THE INVENTION

The working machine disclosed in Japanese Unexamined Patent Application Publication No. 10-331196 has no section that limits the opening degree of the fluid supply port cover when the fluid supply port cover is opened. Thus, there is a problem that the fluid supply port cover or a section in the periphery of the fluid supply port cover is damaged.

Example embodiments of the present invention provide working machines each capable of limiting the opening degree of a fluid supply port cover.

A working machine according to an example embodiment of the present invention includes a machine body, at least one tank provided in the machine body and including a fluid supply port, a cover body to cover the tank, the cover body including a main wall portion and an opening provided in a portion of the main wall portion to expose the fluid supply port, a fluid supply port cover to open and close the opening, and a hinge to support the fluid supply port cover in a rotatable manner, wherein the hinge includes an abutting portion to abut on an abutted portion at an opening peripheral edge portion that is a peripheral edge portion of the opening of the cover body or in a vicinity of the opening peripheral edge portion from an inner side of the machine body to limit rotation in an opening direction of the fluid supply port cover when the fluid supply port cover is rotated and opened.

The hinge may be configured to support the fluid supply port cover rotatably upward and downward. The abutting portion may be configured to abut on the abutted portion such that a weight of the fluid supply port cover acts in a direction that causes the fluid supply port cover to rotate in the opening direction.

At least one of the abutted portion or the abutting portion may be provided with an elastic body. The abutting portion may be configured to abut on the abutted portion via the elastic body.

The elastic body may include a trim attached to at least a portion of the opening peripheral edge portion that corresponds to the abutted portion.

The hinge may include a pivot provided on an inner surface of the main wall portion of the cover body in a vicinity of the opening, and a hinge arm including a proximal portion supported by the pivot rotatably and a distal end section fixed to the fluid supply port cover. The abutting portion may be provided between the proximal portion and the distal end section of the hinge arm.

The hinge arm may include the proximal portion, the abutting portion including a proximal end portion connected to the proximal portion, and an intermediate arm portion including one end portion connected to a distal end portion of the abutting portion and another end portion connected to the distal end section. The intermediate arm portion may be configured such that, when the fluid supply port cover closes the opening, the one end portion of the intermediate arm portion may be connected to the abutting portion in a region facing the inner surface of the main wall portion, a middle portion of the intermediate arm portion may extend to a region facing an inner surface of the fluid supply port cover through a region facing the abutted portion on a machine-body inner side, and the other end portion of the intermediate arm portion may be connected to the distal end section in the region facing the inner surface of the fluid supply port cover.

When the fluid supply port cover is opened to an extent that the abutting portion and the abutted portion abut on each other, the one end portion of the intermediate arm portion may be located in the opening, the other end portion of the intermediate arm portion may be located in a region facing an outer surface of the main wall portion of the cover body, and the fluid supply port cover may be located in the region facing the outer surface of the main wall portion of the cover body such that the fluid supply port cover is separated from the main wall portion.

The hinge may be adjacent to the fluid supply port, and the fluid supply port may be inclined such that an opening plane is inclined to face away from the hinge.

The intermediate arm portion may have a curved shape or a bent shape which is convex in a direction away from a rotation axis of the hinge. The abutting portion may have a flat shape to abut on the abutted portion in a surface contact manner.

The cover body may include the main wall portion, the opening peripheral edge portion, and a connection portion connecting the main wall portion and the opening peripheral edge portion to each other. The connection portion may be bent or curved toward an interior of the machine body from the main wall portion. The abutted portion may be provided at the opening peripheral edge portion or at a position on the connection portion that is located inward of the main wall portion with respect to the machine body.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is an overall side view of a working machine.

FIG. 2 is a left perspective view of a machine body and an operation unit.

FIG. 3 is a plan view of the machine body.

FIG. 4 is a right perspective view of the machine body and the operation unit.

FIG. 5 is a front view of a right portion of the working machine.

FIG. 6 is an exploded perspective view of a fourth cover body.

FIG. 7 is a front sectional view of the machine body and the fourth cover body.

FIG. 8 is a side sectional view of the machine body and the fourth cover body.

FIG. 9 is a perspective view of an opening providing portion.

FIG. 10A is a plan view of a front portion of the fourth cover body.

FIG. 10B is an enlarged front view of a pivot portion of a fluid supply port cover.

FIG. 10C is a plan view of an abutting area of an abutting portion with respect to an abutted portion.

FIG. 10D is a plan view of a front portion of a fourth cover body according to a variation.

FIG. 10E is a sectional view illustrating an end portion of an opening peripheral edge portion.

FIG. 11 is a perspective view of the fluid supply port cover.

FIG. 12 is a side sectional view of an upper portion of a tank cover portion.

FIG. 13 is a side sectional view illustrating a state in which the fluid supply port cover is closed.

FIG. 14 is a side sectional view illustrating a state in which the fluid supply port cover is opened.

FIG. 15 is a perspective view of a hinge.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Hereinafter, example embodiments of the present invention will be described with reference to the drawings as appropriate.

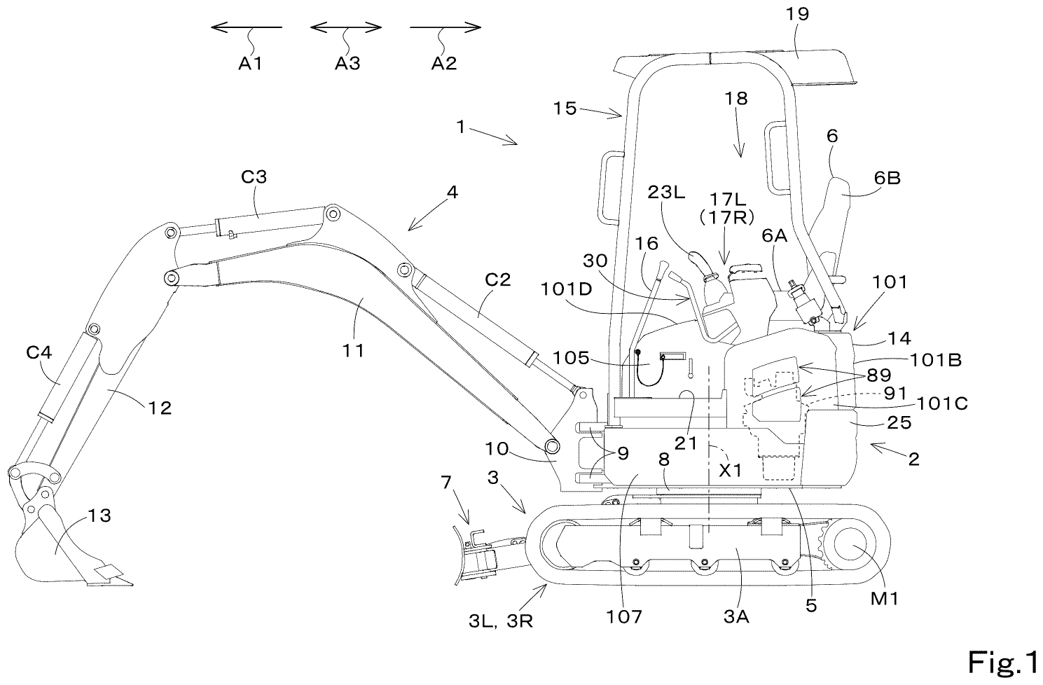

FIG. 1 is a schematic side view illustrating an overall configuration of a working machine 1 according to the present example embodiment. In the present example embodiment, a backhoe, which is a turning working machine, is exemplified as the working machine 1.

As illustrated in FIG. 1, the working machine 1 includes a machine body (swivel base) 2, a traveling device 3, and a working device 4. An operator's seat 6 on which an operator is seated and a four-pillar-type ROPS 15 are provided on the machine body 2. The operator's seat 6 includes a seat portion 6A and a back rest portion 6B. The seat portion 6A is a section on which the operator is seated (the hip and the thighs are placed). The back rest portion 6B is a section on which the seated operator leans his/her back, and is provided at a rear portion of the seat portion 6A so as to extend upward. The ROPS 15 has a canopy specification including a roof 19. Thus, the working machine 1 of the present example embodiment is a working machine 1 in which the periphery of the operator's seat 6 is not covered with a wall surface and is open to the outside.

In the present example embodiment, a direction toward the front of the operator seated on the operator's seat 6 of the working machine 1 (arrow A1 direction in FIG. 1) is described as a forward side (machine-body forward side), a direction toward the rear of the operator (arrow A2 direction in FIG. 1) is described as a rearward side (machine-body rearward side), and an arrow A3 direction in FIG. 1 is described as a front-rear direction (machine-body front-rear direction). Also, a direction toward the left of the operator (near side in FIG. 1) is described as a leftward side, and a direction toward the right of the operator (far side in FIG. 1) is described as a rightward side.

Also, a horizontal direction that is a direction orthogonal to the front-rear direction A3 is described as a machine-body width direction. A direction from a central portion to a right portion or a left portion in a width direction of the machine body 2 is described as an outward side in the machine-body width direction. That is, the outward side in the machine-body width direction is a direction away from the center in the width direction of the machine body 2 in the machine-body width direction. A direction opposite to the outward side in the machine-body width direction is described as an inward side in the machine-body width direction. That is, the inward side in the machine-body width direction is a direction toward the center in the width direction of the machine body 2 in the machine-body width direction.

As illustrated in FIG. 1, the traveling device 3 is a crawler type traveling device that supports the machine body 2 so as to be travelable, and includes a traveling frame 3A, a first traveling device 3L provided leftward of the traveling frame 3A, and a second traveling device 3R provided rightward of the traveling frame 3A. The first traveling device 3L and the second traveling device 3R are driven by a traveling motor M1 including a hydraulic motor (hydraulic actuator). In the present example embodiment, the crawler type traveling device 3 is used, but this does not imply any limitation, and a wheel type traveling device or the like may be used. A dozer device 7 is attached to a front portion of the traveling device 3. The dozer device 7 can be driven by a dozer cylinder including a hydraulic cylinder (hydraulic actuator).

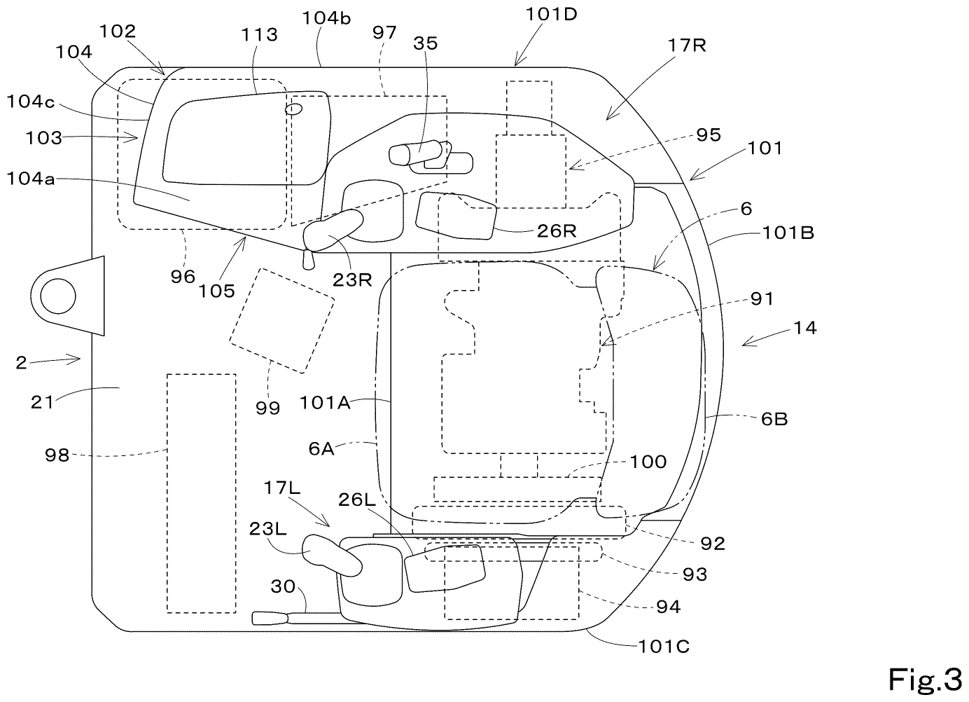

As illustrated in FIG. 1, the machine body 2 includes a swivel base plate 5 that is made of a thick plate and defines a bottom portion of the machine body 2. The swivel base plate 5 is supported on the traveling frame 3A of the traveling device 3 via a turning bearing 8 so as to be turnable about a turning axis X1 that is an axis extending in an up-down direction. The swivel base plate 5 is driven to turn about the turning axis X1 by a turning motor 99 (see FIG. 3). Additionally, the machine body 2 includes, at a front portion thereof, a support bracket 9 and a swing bracket 10 that support the working device 4. The support bracket 9 protrudes forward from the machine body 2. Specifically, the support bracket 9 is fixed to a front portion of the swivel base plate 5 and protrudes forward from the swivel base plate 5. The swing bracket 10 is attached to a front portion of the support bracket 9 so as to be swingable about a vertical axis (an axis extending in the up-down direction).

As illustrated in FIG. 1, the working device 4 includes a boom 11, an arm 12, and a bucket 13. A proximal portion of the boom 11 is pivotally attached to an upper portion of the swing bracket 10 so as to be rotatable about a horizontal axis (an axis extending in the machine-body width direction). The arm 12 is pivotally attached to a distal end portion of the boom 11 so as to be rotatable about a horizontal axis. The bucket 13 is provided at a distal end portion of the arm 12 so as to be capable of performing a shoveling motion and a dumping motion. The shoveling motion is a motion of swinging the bucket 13 in a direction toward the boom 11, and is, for example, a motion of shoveling earth and sand or the like. Also, the dumping motion is a motion of swinging the bucket 13 in a direction away from the boom 11, and is, for example, a motion of dropping (discharging) shoveled earth and sand or the like.

The swing bracket 10 is swingable by extension/contraction of a swing cylinder (not illustrated). The boom 11 is swingable by extension/contraction of a boom cylinder C2. The arm 12 is swingable by extension/contraction of an arm cylinder C3. The bucket 13 is capable of performing the shoveling motion and the dumping motion by extension/contraction of a bucket cylinder C4. The swing cylinder, the boom cylinder C2, the arm cylinder C3, and the bucket cylinder C4 include hydraulic cylinders (hydraulic actuators).

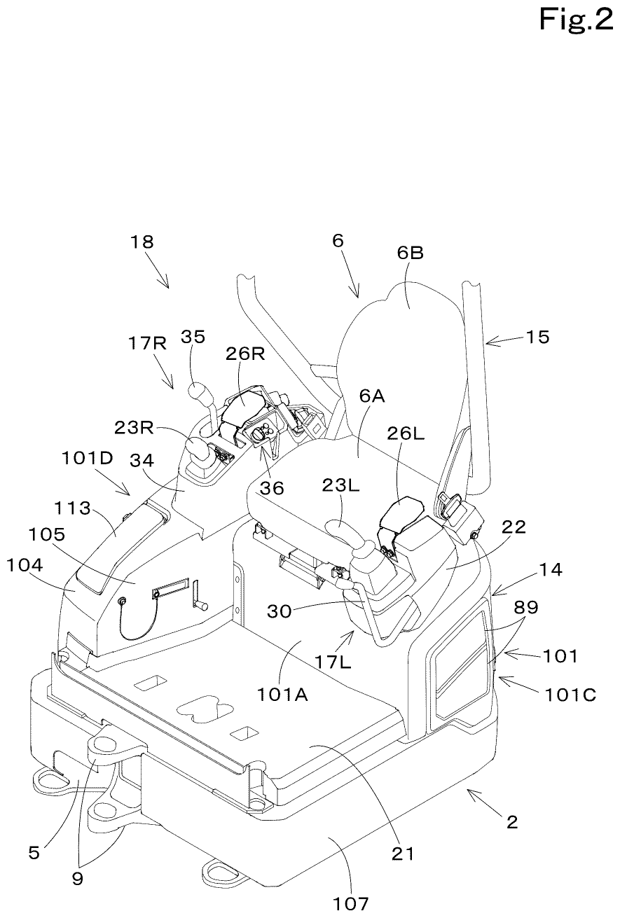

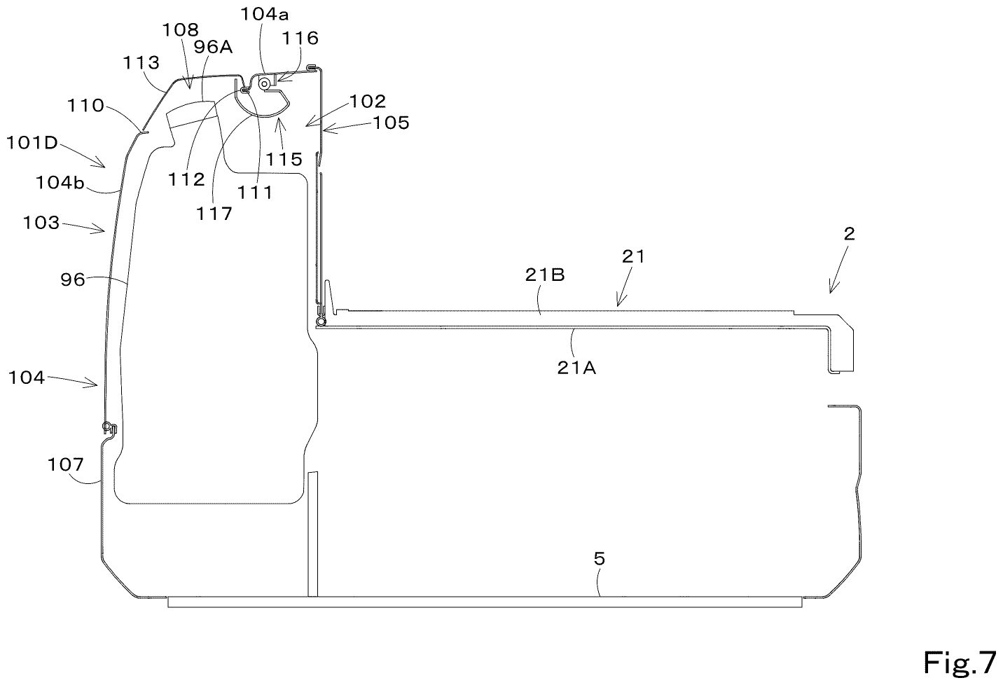

As illustrated in FIG. 2, an operation unit 18 is provided on the machine body 2. The operation unit 18 includes the operator's seat 6, a traveling lever 16 (see FIG. 1) arranged forward of the operator's seat 6, a manipulator (left manipulator) 17L arranged leftward of the operator's seat 6 and a manipulator (right manipulator) 17R arranged rightward of the operator's seat 6, and the like. The traveling lever 16 is usable to operate the traveling device 3. The manipulators 17L and 17R are devices that operate the working device 4, the machine body 2, and the like. Specifically, the manipulators 17L and 17R are devices that perform, for example, a swinging operation of the boom 11, a swinging operation of the arm 12, operations of the shoveling motion and the dumping motion of the bucket 13, a turning operation of the machine body 2, and the like. A floor portion 21 that is a portion on which the operator places his/her feet is provided on an upper surface of the machine body 2 and forward of the operator's seat 6. The floor portion 21 is provided by, for example, a floor mat 21B being laid on a step plate 21A that is arranged above the swivel base plate 5 with a space interposed and supported by the swivel base plate 5 (see FIG. 7). A weight 25 that balances the weight with the working device 4 is arranged at a rear portion of the machine body 2. The working machine 1 of the present example embodiment is a compact backhoe. As illustrated in FIG. 1, the operator's seat 6 is arranged above a prime mover 91 (a prime mover room that houses the prime mover 91).

The left manipulator 17L includes a console cover 22, a manipulating lever (left manipulating lever) 23L, a remote control valve, an armrest 26L, and an operation lock lever (unloading lever) 30.

The console cover 22 covers the remote control valve, a frame mechanism of the left manipulator 17L, and the like. The left manipulating lever 23L is arranged at a front and upper portion of the left manipulator 17L, and is operable to be tilted forward/rearward and leftward/rightward. The remote control valve is a pilot valve that is operated with the left manipulating lever 23L, and is arranged below the left manipulating lever 23L. The remote control valve is housed in the console cover 22. The armrest 26L is a structure on which an elbow and the like of the operator is placed, and is arranged rearward of the left manipulating lever 23L. The operation lock lever 30 is a lever that switches a hydraulic actuator provided in the working machine 1 between an operable state and an inoperable state.

As illustrated in FIG. 2, the right manipulator 17R includes a console cover 34, a manipulating lever (right manipulating lever) 23R, a remote control valve (not illustrated), an armrest 26R, a dozer lever 35, and a plurality of switches 36.

The console cover 34 is a cover that covers a frame of the right manipulator 17R. The frame of the right manipulator 17R is attached to the machine body 2. The right manipulating lever 23R is arranged at a front and upper portion of the right manipulator 17R, and is operable to be tilted forward/rearward and leftward/rightward. The remote control valve is a pilot valve that is operated with the right manipulating lever 23R, and is arranged below the right manipulating lever 23R and covered with the console cover 34. The armrest 26R is a structure on which an elbow and the like of the operator is placed, and is arranged rearward of the right manipulating lever 23R. The dozer lever 35 is a lever that operates the dozer device 7. The plurality of switches 36 are arranged at an upper surface of the console cover 34, and are switches that operate various devices provided in the working machine 1.

As illustrated in FIG. 3, mounted objects such as the prime mover 91, a radiator 92, an oil cooler 93, a battery 94, a hydraulic pump 95, a fuel tank (tank) 96, a hydraulic fluid tank (tank) 97, a control valve 98, and the turning motor 99 are provided in the machine body 2. The prime mover 91 is, for example, a diesel engine. The prime mover 91 may be a gasoline engine or an electric motor, or may be a hybrid type including an engine and an electric motor. A cooling fan 100 is attached to one side in the machine-body width direction (left portion) of the prime mover 91. The cooling fan 100 is driven by the prime mover 91 and generates cooling air flowing from the left to the right. In other words, the cooling fan 100 is a suction type fan that sucks air (outside air) from the left of the machine body 2 and causes the air to flow toward the prime mover 91.

The radiator 92 is a cooler that cools a coolant for cooling the prime mover 91. The oil cooler 93 is a cooler that cools a return hydraulic fluid that returns from a hydraulic actuator such as a hydraulic cylinder or a hydraulic motor. The battery 94 is a storage battery that supplies electric power to an electrical component provided in the working machine 1. The hydraulic pump 95 is driven with power of the prime mover 91, and delivers a hydraulic fluid (pressure fluid) for driving a hydraulic actuator such as a hydraulic motor or a hydraulic cylinder provided in the working machine 1. Also, the hydraulic pump 95 delivers a pilot pressure to actuate a hydraulic valve and a pressure fluid for a signal. The fuel tank 96 is a tank that stores fuel for the prime mover 91. The hydraulic fluid tank 97 is a tank that stores the hydraulic fluid. The control valve 98 controls the flow rate of the hydraulic fluid that is supplied to the hydraulic actuator that is driven with the hydraulic fluid delivered from the hydraulic pump 95. The turning motor 99 includes a hydraulic motor (hydraulic actuator) and is a motor that turns (rotationally drives) the machine body 2 about the turning axis X1.

As illustrated in FIG. 3, the prime mover 91 is arranged in the rear portion of the machine body 2 and in a middle portion in the width direction of the machine body 2. Also, the prime mover 91 is arranged below the operator's seat 6. The radiator 92 is arranged leftward of the prime mover 91 and the cooling fan 100. The oil cooler 93 is arranged leftward of the radiator 92. The battery 94 is arranged leftward of the oil cooler 93 and lower than the oil cooler 93. The hydraulic pump 95 is attached to another side in the machine-body width direction (right portion) of the prime mover 91. The fuel tank 96 is arranged in a right portion of the machine body 2 and in the front portion of the machine body 2. In other words, the fuel tank 96 is arranged rightward and forward of the operator's seat 6. The hydraulic fluid tank 97 is arranged rearward of the fuel tank 96 and forward of the hydraulic pump 95. In other words, the hydraulic fluid tank 97 is arranged in the right portion and in a middle portion in the front-rear direction of the machine body 2. The control valve 98 is arranged in a front and left portion of the machine body 2. The turning motor 99 is arranged in the middle portion in the front-rear direction of the machine body 2 and in the middle portion in the width direction of the machine body 2. Also, the turning motor 99 is arranged forward of the operator's seat 6 and lower than the operator's seat 6.

As illustrated in FIG. 1, a cover device 101 is provided above the machine body 2, to cover mounted objects including mounted devices such as the prime mover 91 and mounted structural elements such as the tanks provided in the machine body 2. As illustrated in FIG. 3, the cover device 101 covers the prime mover 91, the radiator 92, the oil cooler 93, the battery 94, the hydraulic pump 95, the fuel tank 96, and the hydraulic fluid tank 97. The control valve 98 and the turning motor 99 are arranged inside the machine body 2 (below the floor portion 21).

The cover device 101 includes a plurality of cover bodies 101A to 101D. The plurality of cover bodies 101A to 101D include a cover body (referred to as a first cover body) 101A arranged below the operator's seat 6. The first cover body 101A is provided in a fixed manner with respect to the machine body 2. Also, the first cover body 101A covers the upper side and the front of the prime mover 91. Also, the plurality of cover bodies 101A to 101D include a cover body (referred to as a second cover body) 101B arranged rearward of the first cover body 101A and the prime mover 91. The second cover body 101B is openable and closable and is configured to cover the rear of the prime mover 91. A right end portion of the second cover body 101B is supported so as to be rotatable about an axis extending in the up-down direction with respect to the machine body 2, and therefore the second cover body 101B is openable and closable. Also, the plurality of cover bodies 101A to 101D include a cover body (referred to as a third cover body) 101C arranged leftward of the prime mover 91, the radiator 92, and the oil cooler 93. The third cover body 101C is openable and closable and covers the left of the prime mover 91 and the like. The third cover body 101C is provided with an outside air intake port 89 that takes in the outside air to the inner side (the inside of a hood 14 described later) (see FIG. 1). A front end portion of the third cover body 101C is supported so as to be rotatable about an axis extending in the up-down direction with respect to the machine body 2, and therefore the third cover body 101C is openable/closable. Also, the plurality of cover bodies 101A to 101D include a cover body (referred to as a fourth cover body) 101D arranged at the right portion of the machine body 2.

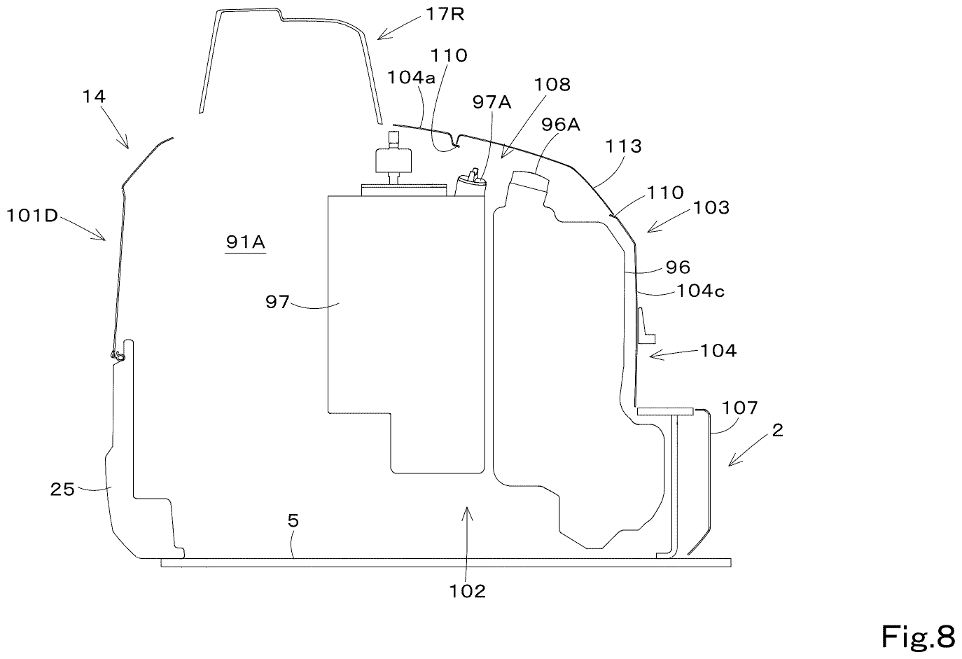

The first cover body 101A, the second cover body 101B, the third cover body 101C, and a rear portion of the fourth cover body 101D define a prime mover room (engine room) that houses the prime mover 91. In other words, the first cover body 101A, the second cover body 101B, the third cover body 101C, and the rear portion of the fourth cover body 101D define the hood 14 that defines the prime mover room. The prime mover room houses the radiator 92, the oil cooler 93, the battery 94, the hydraulic pump 95, and the like, in addition to the prime mover 91. A front portion of the fourth cover body 101D defines a tank room 102 that houses the fuel tank 96 and the hydraulic fluid tank 97 (see FIG. 8). In other words, the front portion of the fourth cover body 101D defines a tank cover portion 103 that defines the tank room 102. That is, it can be also said that the cover device 101 includes the hood 14 and the tank cover portion 103. While the fuel tank 96 and the hydraulic fluid tank 97 are arranged in the tank cover portion 103 (fourth cover body 101D), it is sufficient that at least one tank (for example, the fuel tank 96) is provided. The tank room 102 communicates with a prime mover room 91A (see FIG. 8). The fourth cover body 101D is provided rightward of the operator's seat 6 so as to extend forward with respect to the operator's seat 6. That is, the front portion (tank cover portion 103) of the fourth cover body 101D extends forward with respect to the operator's seat 6 from a lateral side of the operator's seat 6.

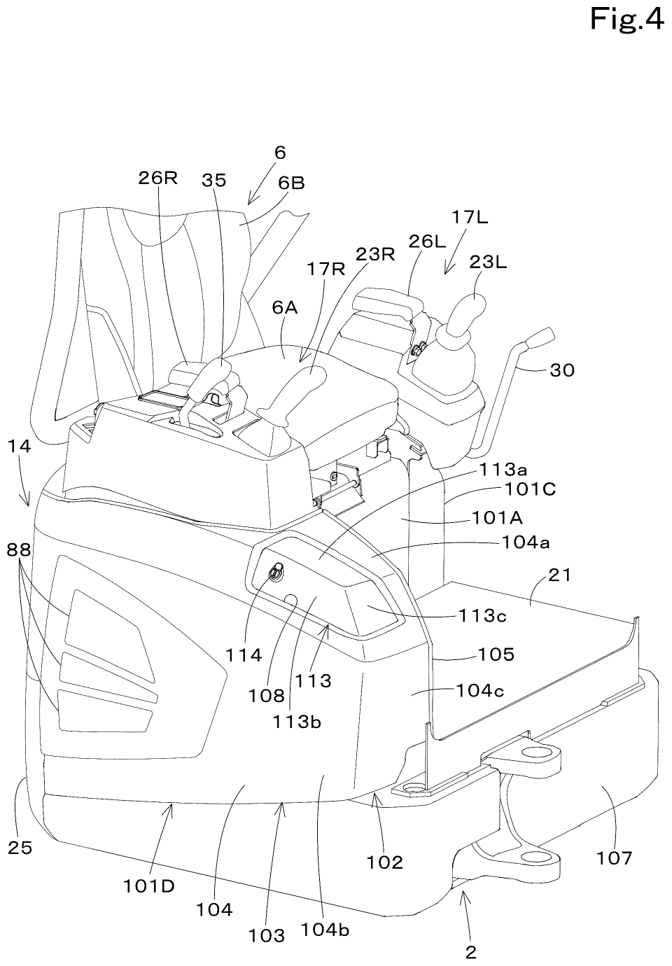

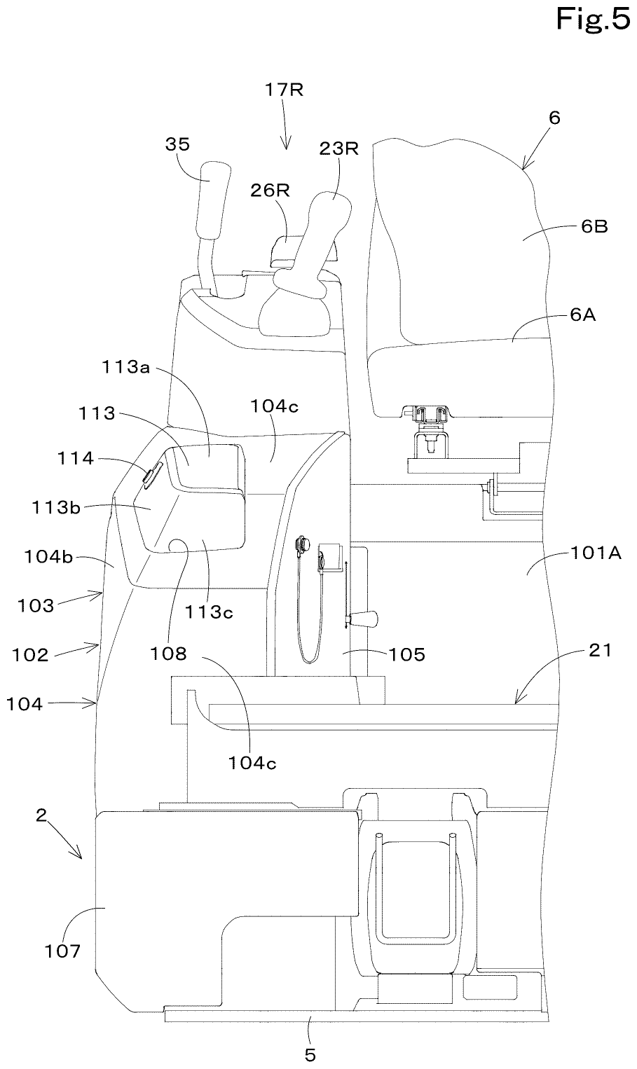

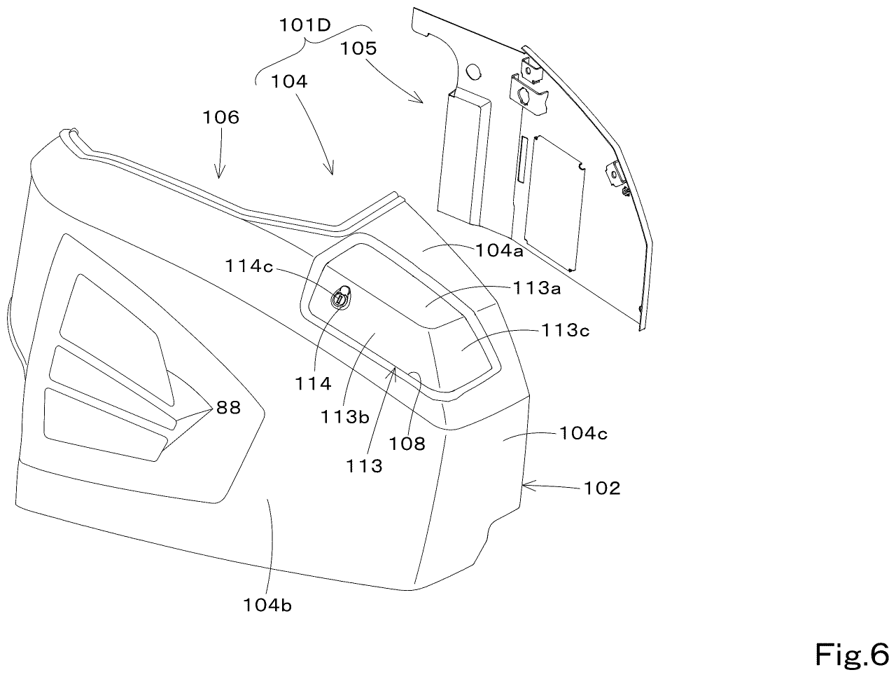

As illustrated in FIGS. 4 to 8, the fourth cover body 101D includes a main cover (main wall portion) 104 and a side surface cover (side wall portion) 105. The main cover 104 and the side surface cover 105 are made of metal plates (sheet metals). The main cover 104 and the side surface cover 105 may be made of plates such as resin plates. The main cover 104 includes an upper wall 104a, a side wall 104b, and a front wall 104c. The upper wall 104a defines a front portion of an upper surface of the fourth cover body 101D, and defines an upper surface of the tank room 102. The upper wall 104a is slightly inclined downward toward the front. As illustrated in FIG. 6, a middle portion in the front-rear direction and a rear portion of the upper surface of the fourth cover body 101D are provided as a cutout portion 106 that is cut out from the middle portion to the rear portion. The right manipulator 17R is arranged above the cutout portion 106 (see FIG. 4).

As illustrated in FIGS. 3 and 4, the side wall 104b defines a right side surface of the fourth cover body 101D. Specifically, the side wall 104b is provided from the front portion to the rear portion of the machine body 2, and defines a right side surface of the tank room 102 and a right side surface of the prime mover room 91A. A discharge port 88 to discharge the air taken into the hood 14 is in a rear portion of the side wall 104b (see FIGS. 4 and 6). The side wall 104b includes an upper portion inclined downward toward the right, and a lower portion extending in the up-down direction (see FIG. 7). As illustrated in FIG. 4, the front wall 104c defines a front surface of the fourth cover body 101D. In other words, the front wall 104c defines a front surface of the tank room 102. The front wall 104c extends downward from a front portion of the upper wall 104a. The front wall 104c includes an upper portion inclined downward toward the front, and a lower portion extending in the up-down direction (see FIG. 8).

As illustrated in FIGS. 7 and 8, a lower surface of the tank room 102 includes the swivel base plate 5, and a front surface and a right side surface of a lower portion of the tank room 102 include a machine body cover 107. The machine body cover 107 is a cover that defines the outer contours of a front surface, a left side surface, and a right side surface of the machine body 2.

As illustrated in FIG. 7, the side surface cover 105 defines an upper portion of a left side surface of the tank room 102. In other words, the side surface cover 105 defines a side wall portion, facing the operator's seat 6, of the front portion of the fourth cover body (cover body) 101D. A lower portion of the left side surface of the tank room 102 communicates with the inside of the machine body 2.

As illustrated in FIG. 8, the fuel tank 96 and the hydraulic fluid tank 97 have fluid supply ports 96A and 97A in upper portions thereof. The fluid supply port 96A of the fuel tank 96 is referred to as a fuel supply port, and the fluid supply port 97A of the hydraulic fluid tank 97 is referred to as a hydraulic fluid supply port. The fuel supply port 96A includes a tubular portion that extends upward from a main body portion of the fuel tank 96, communicates with the inside of the fuel tank 96, and has an upper end opening, and a cap that closes the upper end opening of the tubular portion. The hydraulic fluid supply port 97A also includes a tubular portion that extends upward from a main body portion of the hydraulic fluid tank 97, communicates with the inside of the hydraulic fluid tank 97, and has an upper end opening, and a cap that closes the upper end opening of the tubular portion.

As illustrated in FIG. 8, the fuel supply port 96A is provided at a rear portion of an upper surface of the fuel tank 96. Also, as illustrated in FIG. 7, the fuel supply port 96A is provided near the right with respect to a central portion in the machine-body width direction. As illustrated in FIG. 8, the hydraulic fluid supply port 97A is provided at a front portion of an upper surface of the hydraulic fluid tank 97. Also, the hydraulic fluid supply port 97A is provided at a substantially central portion in the machine-body width direction. The fuel supply port 96A is arranged forward of the hydraulic fluid supply port 97A.

As illustrated in FIG. 7, the fuel supply port 96A is inclined in an inclination direction to shift outward in the machine-body width direction (rightward) as extending upward. Also, as illustrated in FIG. 8, the fuel supply port 96A is inclined in an inclination direction to shift forward as extending upward. In other words, the fuel supply port 96A is inclined in a direction away from the hydraulic fluid supply port 97A as extending upward. Accordingly, it is possible to prevent or reduce that the hydraulic fluid supply port 97A becomes an obstacle when the fuel is supplied.

As illustrated in FIGS. 6, 9, 10A, and the like, the fourth cover body 101D (tank cover portion 103) is provided with an opening 108 to expose the fuel supply port 96A and the hydraulic fluid supply port 97A. The fuel supply port 96A and the hydraulic fluid supply port 97A are accessible through the opening 108. Specifically, the fuel can be supplied from the fuel supply port 96A through the opening 108, and the hydraulic fluid can be supplied from the hydraulic fluid supply port 97A through the opening 108. A device 109 is provided at the upper portion of the fuel tank 96 and is located forward of the fuel supply port 96A. The device is visually recognizable through the opening 108. This device 109 is, for example, a full sensor that detects the full of fuel.

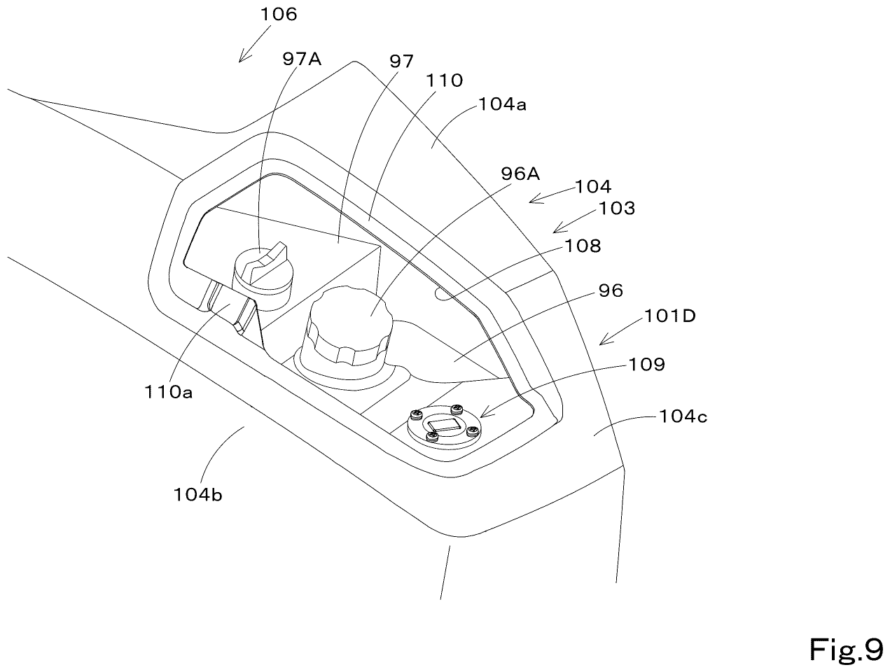

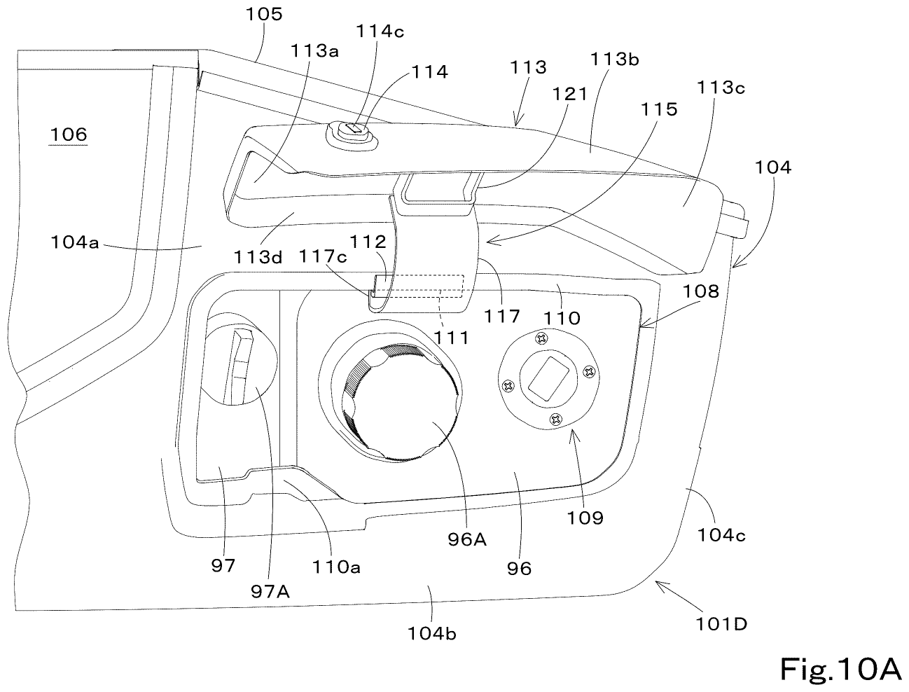

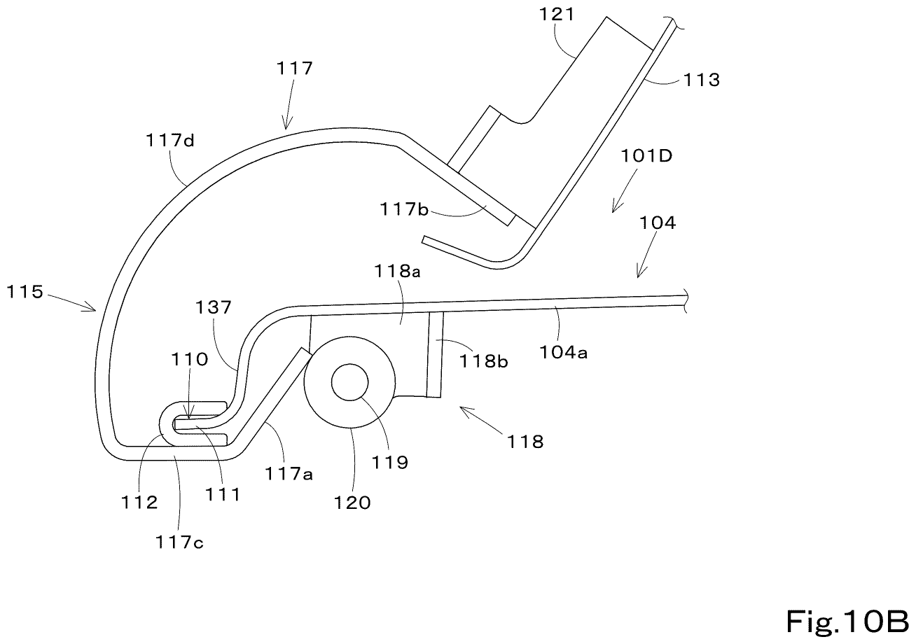

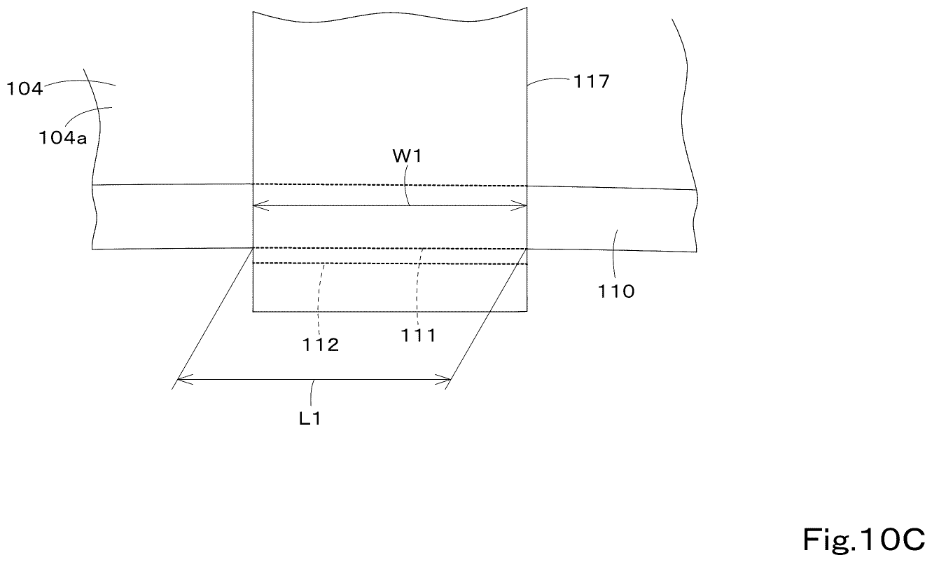

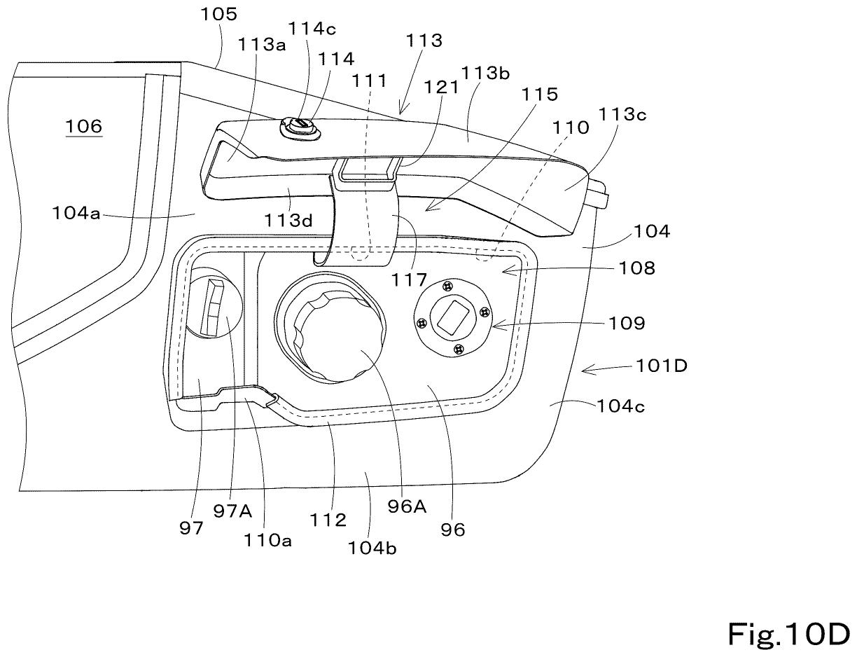

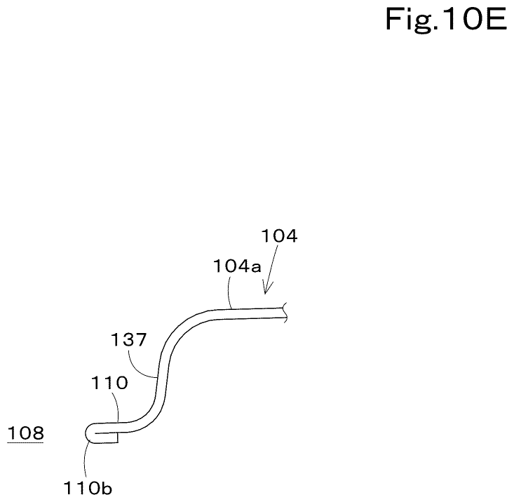

As illustrated in FIGS. 6, 7, and 8, the opening 108 is in a portion of the main cover (main wall portion) 104. Specifically, the opening 108 is provided from a right portion of the upper wall 104a to an upper portion of the side wall 104b and an upper portion of the front wall 104c of the fourth cover body 101D. As illustrated in FIGS. 9 and 10A, the opening 108 is defined by an opening peripheral edge portion 110 that is a peripheral edge portion of the opening 108 of the fourth cover body (cover body) 101D. The location where the opening 108 is provided is not limited to the above-described location, and it is sufficient that the opening 108 is provided in a portion of the main cover (main wall portion) 104.

As illustrated in FIGS. 10B, 13, and 14, the opening peripheral edge portion 110 is connected to the main cover (main wall portion) 104 by a connection portion 137. In other words, the cover body 101D has the connection portion 137 that connects the main cover (main wall portion) 104 and the opening peripheral edge portion 110 to each other.

As illustrated in FIG. 10B, the connection portion 137 is bent or curved toward an interior of the machine body from the main cover (main wall portion) 104, and an abutted portion 111 (described later) is provided at the opening peripheral edge portion 110 or a position on the connection portion 137 that is located inward of the main cover (main wall portion) 104 with respect to the machine body.

As illustrated in FIGS. 7 and 8, the fuel supply port 96A protrudes upward from a right edge portion and a front edge portion of the opening peripheral edge portion 110. Similarly, the hydraulic fluid supply port 97A protrudes upward from the right edge portion and the front edge portion of the opening peripheral edge portion 110.

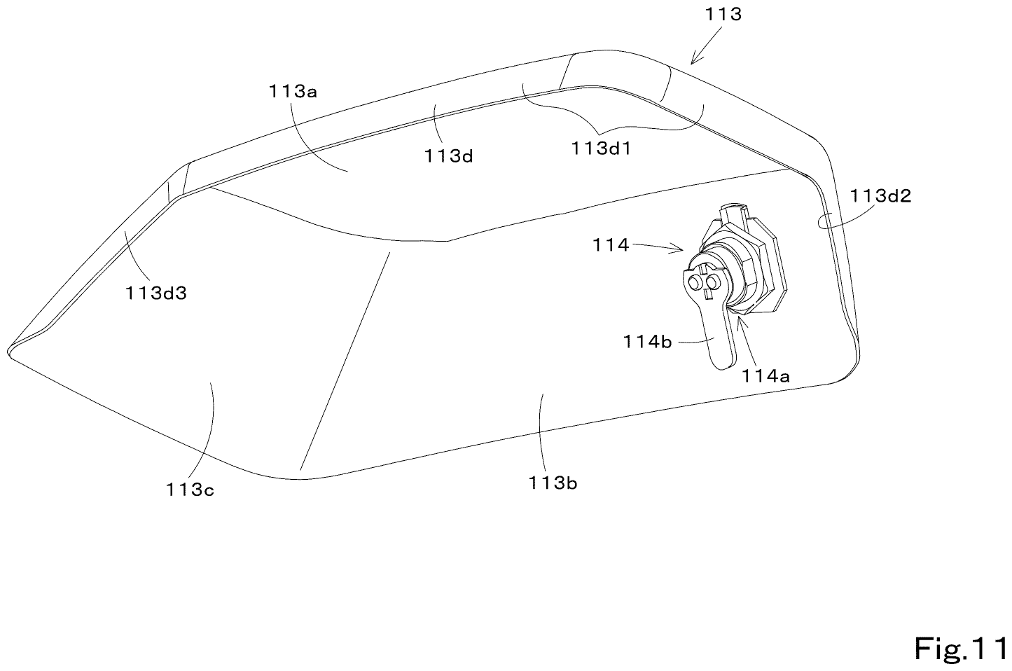

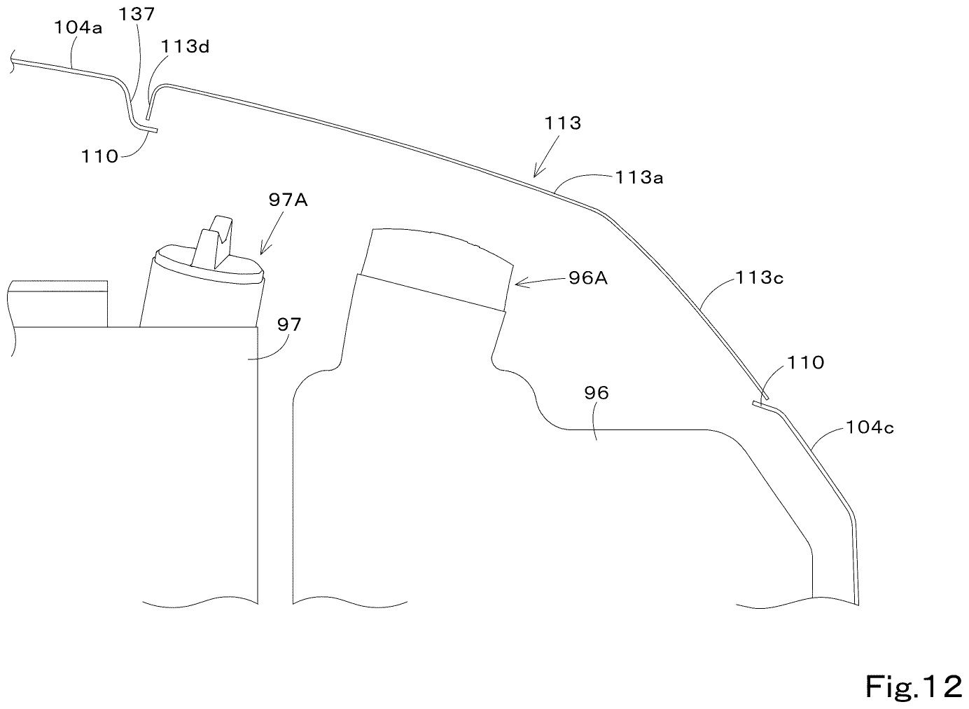

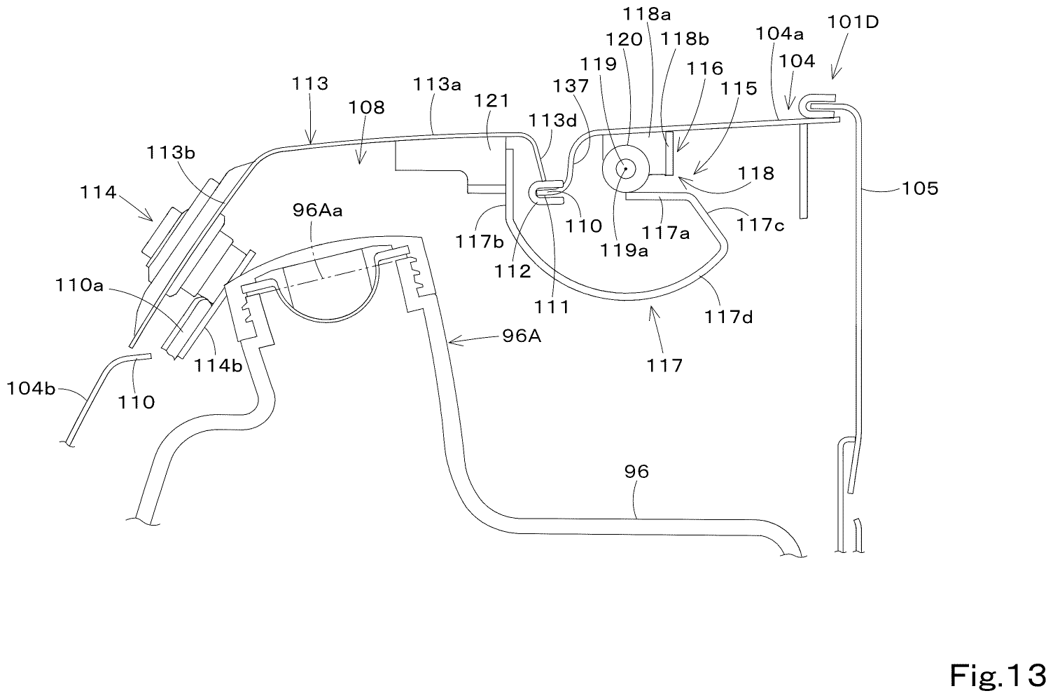

As illustrated in FIGS. 4, 5, and 6, the fourth cover body 101D is provided with a fluid supply port cover 113 that is openable and closable to close the opening 108. As illustrated in FIGS. 6 and 11, the fluid supply port cover 113 includes an upper wall portion 113a, a side wall portion 113b, a front wall portion 113c, and an extension wall portion 113d. As illustrated in FIGS. 12 and 13, in a state in which the fluid supply port cover 113 is closed, the upper wall portion 113a is aligned or substantially aligned with the surface shape of the upper wall 104a of the fourth cover body 101D, the side wall portion 113b is aligned or substantially aligned with the surface shape of the upper portion of the side wall 104b of the fourth cover body 101D, and the front wall portion 113c is aligned or substantially aligned with the surface shape of the upper portion of the front wall 104c of the fourth cover body 101D.

As illustrated in FIG. 11, the extension wall portion 113d includes a section 113d1 extending downward from a left end and a rear end of the upper wall portion 113a, a section 113d2 extending leftward from a rear end of the side wall portion 113b, and a section 113d3 extending rearward from a left end of the front wall portion 113c. As illustrated in FIGS. 12 and 13, in the state in which the fluid supply port cover 113 is closed, a lower end of the side wall portion 113b, a lower end of the front wall portion 113c, and an end portion in an extension direction of the extension wall portion 113d abut on the opening peripheral edge portion 110.

As illustrated in FIG. 11, a cam lock 114 is provided at a rear portion of the side wall portion 113b. The cam lock 114 is a lock in which a metal plate called a cam 114b is attached to a cylinder 114a, and when a key is inserted into a keyhole 114c (see FIG. 6) and the key is tuned, the cam 114b moves, and therefore locking/unlocking can be performed. As illustrated in FIG. 13, the cam lock 114 abuts on (engages with) an engagement portion 110a at the right edge portion of the opening peripheral edge portion 110 in the state in which the fluid supply port cover 113 closes the opening 108, and limits rotation in an opening direction of the fluid supply port cover 113.

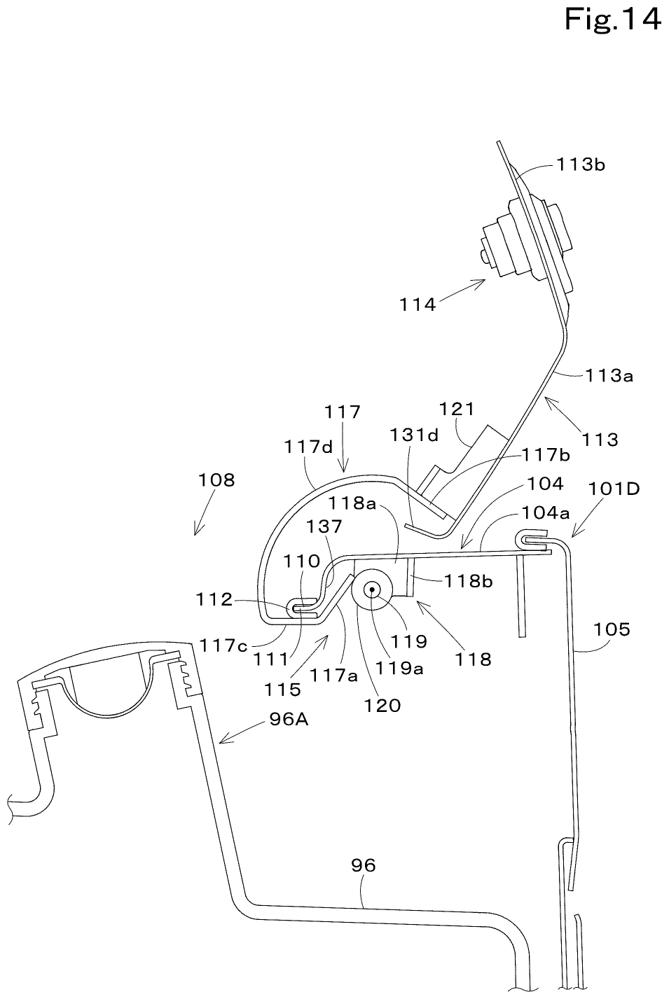

As illustrated in FIGS. 13 and 14, the fluid supply port cover 113 is supported by the fourth cover body 101D via a hinge 115. The hinge 115 supports the fluid supply port cover 113 rotatably upward and downward. The fluid supply port cover 113 opens/closes the opening 108 by rotating upward/downward. Specifically, the fluid supply port cover 113 opens the opening 108 as illustrated in FIG. 14 by being rotated upward from the state in which the opening 108 is closed as illustrated in FIG. 13.

As illustrated in FIGS. 10A and 13, the hinge 115 is arranged adjacent to the fuel supply port 96A in the machine-body width direction (horizontal direction). Specifically, the hinge 115 is arranged leftward of the fuel supply port 96A. As described above, the fuel supply port 96A is inclined in the inclination direction to shift rightward as extending upward. That is, the fuel supply port 96A is inclined so as to shift in a direction away from the hinge 115 as extending upward. In other words, as illustrated in FIG. 13, the fuel supply port 96A is inclined such that an opening plane 96Aa is inclined so as to face in the direction away from the hinge 115. Accordingly, it is possible to prevent or reduce that the hinge 115 becomes an obstacle when the fuel is supplied. Also, the arrangement region of the hinge 115 can be widened.

As illustrated in FIG. 13, the hinge 115 includes a pivot 116 and a hinge arm 117. The pivot 116 is provided on an inner surface of the main cover (main wall portion) 104 of the fourth cover body 101D in the vicinity of the opening 108. In the present example embodiment, the pivot 116 is provided on a lower surface of the upper wall 104a of the fourth cover body 101D in the vicinity of the opening 108.

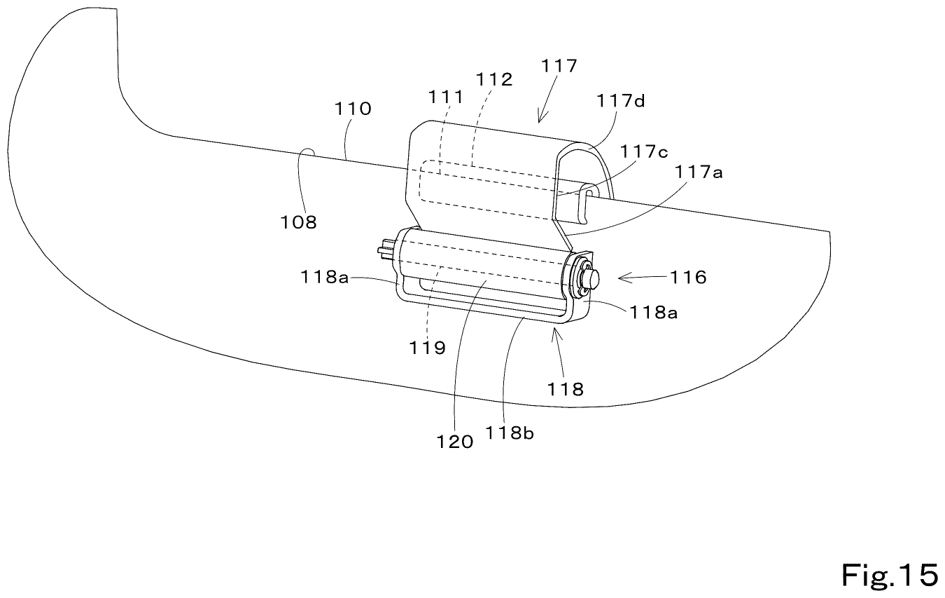

As illustrated in FIG. 15, the pivot 116 includes a support base 118 fixed to the lower surface of the upper wall 104a of the fourth cover body 101D, a pivot shaft 119 supported by the support base 118, and a rotational tube 120 fitted on the pivot shaft 119 so as to be rotatable. The support base 118 includes a pair of support pieces 118a facing each other in the front-rear direction along the upper wall 104a of the fourth cover body 101D, and a coupling portion 118b coupling the pair of support pieces 118a. The pivot shaft 119 is provided to extend between the pair of support pieces 118a. The rotational tube 120 is arranged between the pair of support pieces 118a and is externally fitted on the pivot shaft 119 so as to be rotatable about an axis thereof (rotation axis 119a).

As illustrated in FIG. 10A, the hinge arm 117 is a bent plate strip. As illustrated in FIG. 13, the hinge arm 117 includes a proximal portion 117a, a distal end section 117b, an abutting portion 117c, and an intermediate arm portion 117d. The proximal portion 117a is fixed to the rotational tube 120. That is, the proximal portion 117a is supported by the pivot 116 so as to be rotatable. The distal end section 117b is fixed to a bracket 121 fixed to an inner surface of the fluid supply port cover 113 (a lower surface of the upper wall portion 113a). That is, the distal end section 117b is fixed to the fluid supply port cover 113. The abutting portion 117c extends from the proximal portion 117a. The intermediate arm portion 117d has one end connected to the abutting portion 117c and another end connected to the distal end section 117b.

When the fluid supply port cover 113 is rotated upward from the state in which the fluid supply port cover 113 closes the opening 108 as illustrated in FIG. 13 and the fluid supply port cover 113 is opened as illustrated in FIGS. 10A, 10B, and 14, the abutting portion 117c abuts on the opening peripheral edge portion 110 from the inner side of the machine body 2 and limits the rotation in the opening direction of the fluid supply port cover 113. As illustrated in FIGS. 10A and 10B, a portion of the opening peripheral edge portion 110 on which the abutting portion 117c abuts is the abutted portion 111. In order to limit the rotation in the opening direction of the fluid supply port cover 113, the abutting portion 117c may be configured to directly abut on the abutted portion 111, but in the present example embodiment, the abutting portion 117c abuts on the abutted portion 111 via an elastic body 112 provided at the abutted portion 111. The elastic body 112 is mainly made of an elastic body such as rubber, and in the present example embodiment, the elastic body 112 includes a trim. The trim is an edge trim having a U-shaped cross section with a core metal inserted therein, and is attached to nip the opening peripheral edge portion 110. The elastic body 112 does not have to include the trim, and may include, for example, an elastic plate, an elastic block, or the like. In this case, the elastic body 112 is attached to a lower surface of the abutted portion 111.

Alternatively, the elastic body 112 may be provided on the abutting portion 117c instead of the abutted portion 111. Still alternatively, the elastic body 112 may be provided on both the abutted portion 111 and the abutting portion 117c. That is, it is sufficient that the elastic body 112 is provided on at least one of the abutted portion 111 and the abutting portion 117c.

In a case where the elastic body 112 is provided on the abutting portion 117c, for example, the elastic body 112 is made of an elastic plate, an elastic block, or the like, and is attached to a surface of the abutting portion 117c that abuts on the abutted portion 111.

Also, the abutted portion 111 on which the abutting portion 117c abuts (abuts via the elastic body 112) when the fluid supply port cover 113 is opened does not have to be provided at the opening peripheral edge portion 110. That is, the abutted portion 111 may be provided in the vicinity of the opening peripheral edge portion 110 (for example, the connection portion 137 or the like).

As illustrated in FIG. 10C, a length L1 of the abutted portion 111 is a length corresponding to a width W1 of the hinge arm 117 (abutting portion 117c). However, this does not imply any limitation. Also, the elastic body 112 has a length corresponding to the length L1 of the abutted portion 111. However, this does not imply any limitation. The length of the elastic body 112 may be longer or shorter than the length L1 of the abutted portion 111.

Also, it is sufficient that the trim that is the elastic body 112 is attached to at least a portion of the opening peripheral edge portion 110 corresponding to the abutted portion 111.

FIG. 10D illustrates a variation in a case where a trim as the elastic body 112 is provided. As illustrated in FIG. 10D, the trim as the elastic body 112 is continuously provided from a middle portion of a right edge portion to a front edge portion, a left edge portion, and a rear edge portion of the opening peripheral edge portion 110, while the trim is not provided at the engagement portion 110a that is a rear portion of the right edge portion of the opening peripheral edge portion 110.

In the case where the trim as the elastic body 112 is provided only at the portion of the opening peripheral edge portion 110 corresponding to the abutted portion 111, as illustrated in FIG. 10E, it is desirable that a bent portion 110b provided by an end portion of the opening peripheral edge portion 110 being bent inward is properly provided at a portion other than the abutted portion 111 of the opening peripheral edge portion 110 so that the edge of the opening peripheral edge portion 110 is less likely to be touched with a hand.

Also, as illustrated in FIG. 14, the abutting portion 117c abuts on the abutted portion 111 via the elastic body 112 (or directly) in a state in which the load (weight) of the fluid supply port cover 113 acts in a direction of rotating the fluid supply port cover 113 in the opening direction. Thus, when the abutting portion 117c abuts on the abutted portion 111 (elastic body 112), the fluid supply port cover 113 can be held in the open state. That is, when the fluid supply port cover 113 is held in the open state, the fluid supply port cover 113 is held in the open state by using the opening peripheral edge portion 110 providing the opening 108, without a stopper being additionally provided. Accordingly, the opening degree of the fluid supply port cover 113 is limited, and the fluid supply port cover 113 can be held in the open state while the number of components is not increased. Also, the abutting portion 117c has a flat shape that abuts on the abutted portion 111 (elastic body 112) in a surface contact manner. Also, in the state in which the fluid supply port cover 113 is opened, there is a gap between the fluid supply port cover 113 and the upper surface of the fourth cover body 101D, and the fluid supply port cover 113 does not abut on the fourth cover body 101D. Also, the opening angle is set so that the fluid supply port cover 113 is not closed even when the working machine 1 performs work in a state in which the working machine 1 is inclined at a predetermined angle in a left-up inclined manner with respect to the horizontal (a state in which the working machine 1 is parked on a slope inclined at the predetermined angle with respect to the horizontal) in the state in which the fluid supply port cover 113 is opened. The inclination angle of the working machine 1 (the inclination angle of the slope) at this time is, for example, about 15° to about 17°. However, this does not imply any limitation.

Describing the shape of the hinge arm 117 in the state in which the fluid supply port cover 113 closes the opening 108 as illustrated in FIG. 13, a right end portion of the proximal portion 117a is fixed to a lower end of the rotational tube 120 and extends leftward from the rotational tube 120. The abutting portion 117c extends in an inclination direction to shift downward as extending leftward from a left end of the proximal portion 117a. The intermediate arm portion 117d has a curved shape or a bent shape that is convex in a direction away from the rotation axis 119a of the hinge 115, or a curved shape centered on the rotation axis 119a, extends from a lower end of the abutting portion 117c (a space below the lower surface of the upper wall 104a) toward a space below a lower surface of the fluid supply port cover 113 through a space below the abutted portion 111, and is connected to the distal end section 117b.

In other words, in the state in which the fluid supply port cover 113 closes the opening 108, one end portion of the intermediate arm portion 117d is connected to the abutting portion 117c in a region facing the inner surface of the main cover (main wall portion) 104, a middle portion of the intermediate arm portion 117d extends to a region facing an inner surface of the fluid supply port cover 113 through a region facing the abutted portion 111 on the machine-body inner side, and another end portion of the intermediate arm portion 117d is connected to the distal end section 117b in a region facing the inner surface of the fluid supply port cover 113.

Also, in the state in which the fluid supply port cover 113 opens the opening 108 as illustrated in FIG. 14, the proximal portion 117a extends in an inclination direction to shift downward as extending rightward from a front portion of the rotational tube 120. The abutting portion 117c extends rightward from a lower end of the proximal portion 117a and abuts on the lower surface of the abutted portion 111 via the elastic body 112 (or directly). The intermediate arm portion 117d extends leftward from a right end of the abutting portion 117c through a space above the abutted portion 111 (elastic body 112), the opening peripheral edge portion 110, and the upper wall 104a in a curved direction centered on the axis of the pivot shaft 119, and is connected to the distal end section 117b.

In other words, in the state in which the fluid supply port cover 113 is opened to the state in which the abutting portion 117c and the abutted portion 111 abut on each other, one end portion of the intermediate arm portion 117d is arranged in the opening 108, another end portion of the intermediate arm portion 117d is arranged in a region facing an outer surface of the main cover (main wall portion) 104 of the cover body 101D, and the fluid supply port cover 113 is arranged in a region facing the outer surface of the main cover (main wall portion) 104 of the cover body 101D so as to be separated from the main cover (main wall portion) 104.

Example embodiments of the present invention provide working machines 1 described in the following items.

(Item 1) A working machine 1 including a machine body 2, at least one tank (fuel tank 96, hydraulic fluid tank 97) provided in the machine body 2 and including a fluid supply port (fuel supply port 96A, hydraulic fluid supply port 97A), a cover body (fourth cover body 101D) to cover the tank 96, 97, the cover body 101D including a main wall portion (main cover 104) and an opening 108 provided in a portion of the main wall portion 104 to expose the fluid supply port 96A, 97A, a fluid supply port cover 113 to open and close the opening 108, and a hinge 115 to support the fluid supply port cover 113 in a rotatable manner, wherein the hinge 115 includes an abutting portion 117c to abut on an abutted portion 111 at an opening peripheral edge portion 110 that is a peripheral edge portion of the opening 108 of the cover body 101D or in a vicinity of the opening peripheral edge portion 110 from an inner side of the machine body 2 to limit rotation in an opening direction of the fluid supply port cover 113 when the fluid supply port cover 113 is rotated and opened.

With the working machine 1 according to item 1, when the fluid supply port cover is opened, the abutting portion 117c of the hinge 115 abuts on the abutted portion 111 of the cover body 101D from the inner side of the machine body 2, and therefore the opening degree of the fluid supply port cover 113 can be limited.

(Item 2) The working machine 1 according to item 1, wherein the hinge 115 is configured to support the fluid supply port cover 113 rotatably upward and downward, and the abutting portion 117c is configured to abut on the abutted portion 111 such that a weight of the fluid supply port cover 113 acts in a direction that causes the fluid supply port cover 113 to rotate in the opening direction.

With the working machine 1 according to item 2, the fluid supply port cover 113 can be held in the open state by the weight of the fluid supply port cover 113.

(Item 3) The working machine 1 according to item 1 or 2, wherein at least one of the abutted portion 111 or the abutting portion 117c is provided with an elastic body 112, and the abutting portion 117c is configured to abut on the abutted portion 111 via the elastic body 112.

With the working machine 1 according to item 3, the abutment between the abutting portion 117c and the abutted portion 111 can be buffered.

(Item 4) The working machine 1 according to item 3, wherein the elastic body 112 includes a trim attached to at least a portion of the opening peripheral edge portion 110 that corresponds to the abutted portion 111.

With the working machine 1 according to item 4, the elastic body 112 can be easily assembled.

(Item 5) The working machine 1 according to any one of items 1 to 4, wherein the hinge 115 includes a pivot 116 provided on an inner surface of the main wall portion 104 of the cover body 101D in a vicinity of the opening 108, and a hinge arm 117 including a proximal portion 117a supported by the pivot 116 rotatably and a distal end section 117b fixed to the fluid supply port cover 113, and the abutting portion 117c is provided between the proximal portion 117a and the distal end section 117b of the hinge arm 117.

With the working machine 1 according to item 5, the hinge 115 can be located in the vicinity of the peripheral edge of the opening 108, and the structure of the hinge 115 can be made compact.

(Item 6) The working machine 1 according to item 5, wherein the hinge arm 117 includes the proximal portion 117a, the abutting portion 117c including a proximal end portion connected to the proximal portion 117a, and an intermediate arm portion 117d including one end portion connected to a distal end portion of the abutting portion 117c and another end portion connected to the distal end section 117b, and the intermediate arm portion is configured such that, when the fluid supply port cover 113 closes the opening 108, the one end portion of the intermediate arm portion 117d is connected to the abutting portion 117c in a region facing the inner surface of the main wall portion 104, a middle portion of the intermediate arm portion 117d extends to a region facing an inner surface of the fluid supply port cover 113 through a region facing the abutted portion 111 on a machine-body inner side, and the other end portion of the intermediate arm portion 117d is connected to the distal end section 117b in the region facing the inner surface of the fluid supply port cover 113.

With the working machine 1 according to item 6, the structure of the hinge 115 can be made compact.

(Item 7) The working machine 1 according to item 6, wherein, when the fluid supply port cover 113 is opened to an extent that the abutting portion 117c and the abutted portion 111 abut on each other, the one end portion of the intermediate arm portion 117d is located in the opening 108, the other end portion of the intermediate arm portion 117d is located in a region facing an outer surface of the main wall portion 104 of the cover body 101D, and the fluid supply port cover 113 is located in the region facing the outer surface of the main wall portion 104 of the cover body 101D such that the fluid supply port cover is separated from the main wall portion 104.

With the working machine 1 according to item 7, the hinge 115 can be configured compactly.

(Item 8) The working machine according to any one of items 1 to 7, wherein the hinge 115 is adjacent to the fluid supply port (fuel supply port 96A), and the fluid supply port 96A is inclined such that an opening plane 96Aa is inclined to face away from the hinge 115.

With the working machine 1 according to item 8, the arrangement region of the hinge 115 can be widened.

(Item 9) The working machine according to item 6 or 7, wherein the intermediate arm portion 117d has a curved shape or a bent shape which is convex in a direction away from a rotation axis 119a of the hinge 115, and the abutting portion 117c has a flat shape to abut on the abutted portion 111 in a surface contact manner.

With the working machine 1 according to item 9, the hinge arm 117 can be rotated compactly, and the fluid supply port cover 113 can be held stably.

(Item 10) The working machine according to any one of items 1 to 9, wherein the cover body 101D includes the main wall portion 104, the opening peripheral edge portion 110, and a connection portion 137 connecting the main wall portion 104 and the opening peripheral edge portion 110 to each other, the connection portion 137 is bent or curved toward an interior of the machine body from the main wall portion 104, and the abutted portion 111 is provided at the opening peripheral edge portion 110 or at a position on the connection portion 137 that is located inward of the main wall portion 104 with respect to the machine body.

With the working machine 1 according to item 10, the hinge 115 can be configured compactly.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
a machine body;
at least one tank provided in the machine body and including a fluid supply port;
a cover body to cover the tank, the cover body including a main wall portion and an opening provided in a portion of the main wall portion to expose the fluid supply port;
a fluid supply port cover to open and close the opening; and
a hinge to support the fluid supply port cover in a rotatable manner; wherein
the hinge includes an abutting portion to abut on an abutted portion at an opening peripheral edge portion that is a peripheral edge portion of the opening of the cover body or in a vicinity of the opening peripheral edge portion from an inner side of the machine body to limit rotation in an opening direction of the fluid supply port cover such that the fluid supply port cover does not abut on the cover body from the inner side of the machine body when the fluid supply port cover is rotated and opened.

2. The working machine according to claim 1, wherein
the hinge is configured to support the fluid supply port cover rotatably upward and downward; and
the abutting portion is configured to abut on the abutted portion such that a weight of the fluid supply port cover acts in a direction that causes the fluid supply port cover to rotate in the opening direction.

3. The working machine according to claim 1, wherein at least one of the abutted portion or the abutting portion is provided with an elastic body, and the abutting portion is configured to abut on the abutted portion via the elastic body.

4. The working machine according to claim 3, wherein the elastic body includes a trim attached to at least a portion of the opening peripheral edge portion that corresponds to the abutted portion.

5. The working machine according to claim 3, wherein
the hinge includes a pivot provided on an inner surface of the main wall portion of the cover body in a vicinity of the opening, and a hinge arm including a plate strip including a proximal portion supported by the pivot rotatably and a distal end section fixed to the fluid supply port cover; and
the abutting portion is provided between the proximal portion and the distal end section of the hinge arm, and the elastic body is provided at the abutted portion to abut on the plate strip.

6. The working machine according to claim 5, wherein
the hinge arm includes the proximal portion, the abutting portion including a proximal end portion connected to the proximal portion, and an intermediate arm portion including one end portion connected to a distal end portion of the abutting portion and another end portion connected to the distal end section; and
the intermediate arm portion is configured such that, when the fluid supply port cover closes the opening, the one end portion of the intermediate arm portion is connected to the abutting portion in a region facing the inner surface of the main wall portion, a middle portion of the intermediate arm portion extends to a region facing an inner surface of the fluid supply port cover through a region facing the abutted portion on a machine-body inner side, and the other end portion of the intermediate arm portion is connected to the distal end section in the region facing the inner surface of the fluid supply port cover.

7. The working machine according to claim 6, wherein, when the fluid supply port cover is opened to an extent that the abutting portion and the abutted portion abut on each other, the one end portion of the intermediate arm portion is located in the opening, the other end portion of the intermediate arm portion is located in a region facing an outer surface of the main wall portion of the cover body, and the fluid supply port cover is located in the region facing the outer surface of the main wall portion of the cover body such that the fluid supply port cover is separated from the main wall portion.

8. The working machine according to claim 1, wherein
the hinge is adjacent to the fluid supply port; and
the fluid supply port is inclined such that an opening plane is inclined to face away from the hinge.

9. The working machine according to claim 6, wherein
the intermediate arm portion has a curved shape or a bent shape which is convex in a direction away from a rotation axis of the hinge; and
the abutting portion has a flat shape to abut on the abutted portion in a surface contact manner.

10. The working machine according to claim 1, wherein
the cover body includes the main wall portion, the opening peripheral edge portion, and a connection portion connecting the main wall portion and the opening peripheral edge portion to each other;
the connection portion is bent or curved toward an interior of the machine body from the main wall portion; and
the abutted portion is provided at the opening peripheral edge portion or at a position on the connection portion that is located inward of the main wall portion with respect to the machine body.
